(19) United States
(12) Patent Application Publication
(10) Pub. No.: US 2024/0184268 A1
(43) Pub. Date: Jun. 6, 2024

(54) ELECTRONIC SYSTEM AND SETTING METHOD FOR ELECTRONIC SYSTEM

(71) Applicant: Midastek Microelectronics Inc., Taipei City (TW)

(72) Inventor: Chung-Ping Tan, Taipei City (TW)

(73) Assignee: Midastek Microelectronics Inc., Taipei City (TW)

(21) Appl. No.: 18/153,366

(22) Filed: Jan. 12, 2023

(30) Foreign Application Priority Data
Dec. 5, 2022 (TW) 111146512

(51) Int. Cl. G05B 19/4155

(52) U.S. Cl. CPC G05B 19/4155; G05B 2219/32398

(57) ABSTRACT

An electronic system and a setting method for the electronic system are provided. The electronic system includes a control source circuit, switches, and electronic devices. The control source circuit provides a driving data string. The driving data string includes multiple driving data with different identification codes. A first terminal of a first switch among the switches is coupled to the control source circuit. A first terminal of a second switch among the switches is coupled to a second terminal of the first switch. A first electronic device among the electronic devices turns off the first switch and receives a first driving data with a first identification code, and turns on the first switch after receiving the first driving data, so that a second electronic device among the electronic devices receives a second driving data with a second identification code.

### CROSS-REFERENCE TO RELATED APPLICATION

This application claims the priority benefit of Taiwan application serial no. 111146512, filed on Dec. 5, 2022. The entirety of the above-mentioned patent application is hereby incorporated by reference herein and made a part of this specification.

### BACKGROUND

### Technical Field

The invention relates to an electronic system and a setting method, and more particularly, to an electronic system and a setting method capable of setting multiple electronic devices.

### Description of Related Art

In some cases, in a system, multiple electronic devices of the same type will perform cooperative operations based on different driving methods. That is, the electronic devices may perform different operations. However, when one of the electronic devices is damaged, the user needs to provide another electronic device and manually set the electronic device. For example, when the second electronic device among the electronic devices is damaged, the user needs to find a backup device capable of performing the same operation as the second electronic device. If the backup device capable of performing the same operation as the second electronic device cannot be found, the user has to manually set the backup device to serve as a new second electronic device. Therefore, how to provide an electronic system and a setting method for setting the electronic devices performing different driving methods is one of the research focuses of those skilled in the art.

### SUMMARY

The invention provides an electronic system and a setting method thereof capable of setting multiple electronic devices.

The invention provides an electronic system including a control source circuit, multiple switches, and multiple electronic devices. The switches are coupled with each other in series. The control source circuit provides a driving data string. The driving data string includes multiple driving data with different identification codes. A first terminal of a first switch among the switches is coupled to the control source circuit. A first terminal of a second switch among the switches is coupled to a second terminal of the first switch. A first electronic device among the electronic devices is coupled to the first terminal of the first switch and a control terminal of the first switch. A second electronic device among the electronic devices is coupled to the first terminal of the second switch and a control terminal of the second switch. The first electronic device turns off the first switch and receives a first driving data with a first identification code, and turns on the first switch after receiving the first driving data, so that the second electronic device receives a second driving data with a second identification code.

The invention provides a setting method for an electronic system. The electronic system includes a control source circuit, multiple switches, and multiple electronic devices. A first terminal of a first switch among the switches is coupled to the control source circuit, and a first terminal of a second switch among the switches is coupled to a second terminal of the first switch. The setting method includes the following. A first electronic device among the electronic devices is coupled to the first terminal of the first switch and a control terminal of the first switch, and a second electronic device among the electronic devices is coupled to the first terminal of the second switch and a control terminal of the second switch. A driving data string is provided by the control source circuit. The driving data string includes multiple driving data with different identification codes. The first switch is turned off and a first driving data with a first identification code is received by the first electronic device. The first switch is turned on by the first electronic device after receiving the first driving data, so that the second electronic device receives a second driving data with a second identification code.

Based on the above, the control source circuit provides the driving data with different identification codes. Based on the arrangement order of the electronic devices and the switching operations of the switches, in the setting method for the electronic system in the invention the driving data may be used to set the driving methods of the electronic devices. In this way, the invention may provide a highly convenient device setting solution.

In order for the aforementioned features and advantages of the invention to be more comprehensible, several embodiments accompanied with drawings are described in detail as follows.

### BRIEF DESCRIPTION OF THE DRAWINGS

FIG. 1 is a schematic diagram of an electronic system according to a first embodiment of the invention.

FIG. 2 is a flowchart of a setting method according to an embodiment of the invention.

FIG. 3 is a schematic diagram of an electronic system according to a second embodiment of the invention.

FIG. 4 is a signal timing diagram of a driving data string, a driving data, and a second control signal according to an embodiment of the invention.

FIG. 5 is another flowchart of a setting method according to an embodiment of the invention.

FIG. 6 is a schematic diagram of an application situation of an electronic device according to an embodiment of the invention.

### DESCRIPTION OF THE EMBODIMENTS

Some embodiments of the invention will be described in detail with reference to the accompanying drawings. For the referential element symbols in the following description, when the same element symbols appear in different drawings, they will be regarded as the same or similar elements. These embodiments are only a part of the invention, and do not reveal all possible implementation modes of the invention. Rather, these embodiments are only examples within the scope of the patent application of the invention.

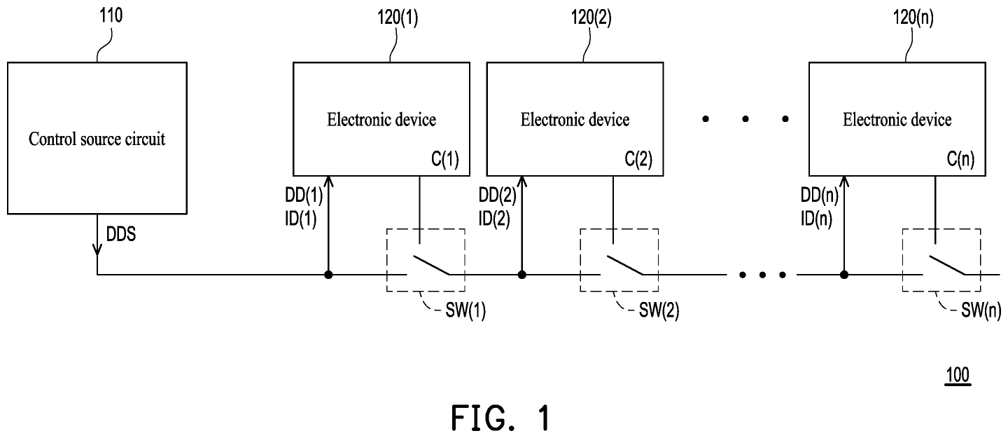

Referring to FIG. 1, which is a schematic diagram of an electronic system according to a first embodiment of the invention. In the embodiment, the electronic system 100 includes a control source circuit 110, switches SW(1) to SW(n), and electronic devices 120(1) to 120(n). The control source circuit 110 provides a driving data string DDS. The driving data string DDS includes driving data DD(1) to DD(n) with different identification codes. For example, the driving data DD(1) has an identification code ID(1). The driving data DD(2) has an identification code ID(2). Similarly, the driving data DD(n) has an identification code ID(n).

In the embodiment, the switches SW(1) to SW(n) are coupled in series with each other. Further, a first terminal of the switch SW(1) is coupled to the control source circuit 110. A first terminal of the switch SW(2) is coupled to a second terminal of the switch SW1. Similarly, a first terminal of the switch SW(n) is coupled to a second terminal of the switch SW(n-1) (not shown). In the embodiment, the switches SW(1) to SW(n) may be implemented by transistor switches or transmission gates.

In the embodiment, the electronic devices 120(1) to 120(n) are coupled to the first terminal of the corresponding switch among the switches SW(1) to SW(n) and a control terminal of the corresponding switch. Specifically, the electronic device 120(1) is coupled to the first terminal of the switch SW(1) and the control terminal of the switch SW(1). The electronic device 120(2) is coupled to the first terminal of the switch SW(2) and the control terminal of the switch SW(2), and so on. In the embodiment, the electronic device 120(1) turns off the switch SW(1) and receives the driving data DD(1) with the identification code ID(1). The electronic device 120(1) turns on the switch SW(1) after receiving the driving data DD(1). Therefore, the electronic device 120(2) may receive the driving data DD(2) with the identification code ID(2) through the turned-on switch SW(1). In the embodiment, the electronic devices 120(1) to 120(n) respectively include at least one of a fan device, a display device, and a light-emitting device.

After the switch SW(1) is turned on, the electronic device 120(1) stops receiving the driving data string DDS. Namely, the electronic device 120(1) does not receive driving data other than the driving data DD(1).

The electronic device 120(2) turns off the switch SW(2) and receives the driving data DD(2) with the identification code ID(2). The electronic device 120(2) turns on the switch SW(2) after receiving the driving data DD(2), and so on. After the switch SW(2) is turned on, the electronic device 120(2) stops receiving the driving data string DDS. Namely, the electronic device 120(2) does not receive driving data other than the driving data DD(2).

In the embodiment, the driving data DD(1) to DD(n) include different driving programs or driving protocols. Therefore, the electronic device 120(1) operates according to the driving data DD(1). The electronic device 120(2) operates according to the driving data DD(2). Similarly, the electronic device 120(n) operates according to the driving data DD(n).

It should be noted that the control source circuit 110 provides the driving data DD(1) to DD(n) with different identification codes. The electronic system 100 utilizes the driving data DD(1) to DD(n) to set the driving modes of the electronic device 120(1) to 120(n) based on the arrangement order of the electronic devices 120(1) to 120(n) and switching operations of the switches SW(1) to SW(n). In this way, the electronic system 100 may provide a simple device setting solution.

In the embodiment, the electronic system 100 uses the driving data DD(1) to DD(n) to perform re-address setting on the electronic devices 120(1) to 120(n).

In the embodiment, the driving data DD(1) to DD(n) are provided sequentially based on an order of the identification codes. For example, based on an order of the identification codes ID(1) to ID(n), the control source circuit 110 provides the driving data DD(1) first, then provides the driving data DD(2), and so on. The electronic devices 120(1) to 120(n) respectively have device codes. The device codes of the electronic devices 120(1) to 120(n) are determined according to the arrangement order of the electronic devices 120(1) to 120(n). For example, based on the arrangement order of the electronic devices 120(1) to 120(n), the electronic device 120(1) has a device code C(1). The electronic device 120(2) has a device code C(2). The electronic device 120(n) has a device code C(n).

For example, the arrangement order of the electronic devices 120(1) to 120(n) may be determined by connection modes of the electronic devices 120(1) to 120(n) and the switches SW(1) to SW(n). Thus, electronic device 120(1) has the device code C(1). The electronic device 120(2) has the device code C(2). The electronic device 120(n) has the device code C(n). For another example, a user may set the device codes C(1) to C(n) of the electronic devices 120(1) to 120(n).

The electronic devices 120(1) to 120(n) identify the identification codes according to the corresponding device codes. The device code C(1) corresponds to the identification code ID(1). The device code C(2) corresponds to the identification code ID(2). Similarly, the device code C(n) corresponds to the identification code ID(n). For example, the device code C(1) is equal to the identification code ID(1). The device code C(2) is equal to the identification code ID(2). The device code C(n) is equal to the identification code ID(n). Therefore, the electronic device 120(1) may identify the driving data DD(1) with the identification code ID(1) from the driving data string DDS based on the device code C(1), and receive the driving data DD(1). The electronic device 120(2) may identify the driving data DD(2) with the identification code ID(2) from the driving data string DDS based on the device code C(2), and receive the driving data DD(2), and so on.

In the embodiment, the number of switches of the electronic system 100 may be increased to expand a setting number of electronic devices.

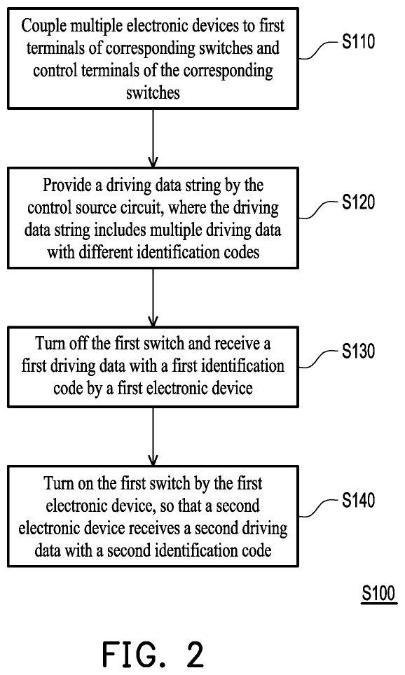

Referring to FIG. 1 and FIG. 2 at the same time, FIG. 2 is a flowchart of a setting method according to an embodiment of the invention. In the embodiment, the setting method S100 is adapted to the electronic system 100. The setting method S100 includes at least steps S110 to S140. In step S110, the electronic devices 120(1) to 120(n) are coupled to the first terminals of the corresponding switches and the control terminals of the corresponding switches. Taking the embodiment as an example, the electronic device 120(1) is coupled to the first terminal of the switch SW(1) and the control terminal of the switch SW(1). The electronic device 120(2) is coupled to the first terminal of the switch SW(2) and the control terminal of the switch SW(2).

In step S120, the control source circuit 110 provides the driving data string DDS. The driving data string DDS includes the driving data DD(1) to DD(n). In step S130, the electronic device 120(1) (i.e., the first electronic device) turns off the switch SW(1) (i.e., the first switch) and receives the driving data DD(1). In step S140, after receiving the driving data DD(1), the electronic device 120(1) turns on the switch SW(1), so that the electronic device 120(2) (i.e., the second electronic device) receives the driving data DD(2). Implementation details of steps S110 to S140 have been clearly described in the embodiment of FIG. 1, which will not be repeated here.

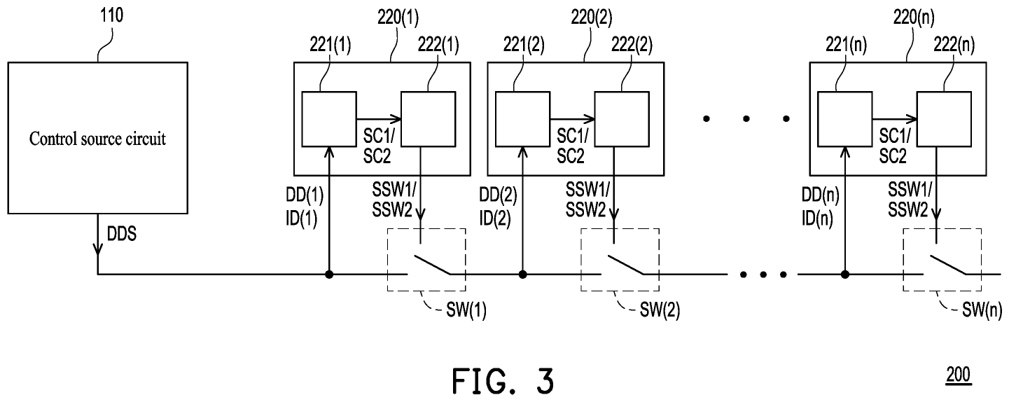

Referring to FIG. 3, FIG. 3 is a schematic diagram of an electronic system according to a second embodiment of the invention. In the embodiment, the electronic system 200 includes a control source circuit 110, switches SW(1) to SW(n), and electronic devices 220(1) to 220(n). The control source circuit 110 provides the driving data string DDS. The driving data string DDS includes driving data DD(1) to DD(n) with different identification codes. The first terminal of the switch SW(1) is coupled to the control source circuit 110. The first terminal of the switch SW(2) is coupled to the second terminal of the switch SW1. Similarly, the first terminal of the switch SW(n) is coupled to the second terminal of the switch SW(n-1) (not shown). The electronic device 220(1) is coupled to the first terminal of the switch SW(1) and the control terminal of the switch SW(1). The electronic device 220(2) is coupled to the first terminal of the switch SW(2) and the control terminal of the switch SW(2), and so on.

In the embodiment, the electronic device 220(1) includes a driver 221(1) and a switch controller 222(1). The driver 221(1) is coupled to the first terminal of the switch SW(1). The driver 221(1) controls the operation of the electronic device 220(1) according to the driving data DD(1). The switch controller 222(1) is coupled to the control terminal of the switch SW(1) and the driver 221(1). The switch controller 222(1) turns off the switch SW(1) in response to a first control signal SC1 from the driver 221(1). The switch controller 222(1) turns on the switch SW(1) in response to a second control signal SC2 from the driver 221(1).

For example, when receiving the driving data DD(1), the driver 221(1) provides the first control signal SC1. Therefore, the switch controller 222(1) provides a switch control signal SSW1 to the control terminal of the switch SW(1) in response to the first control signal SC1. The switch SW(1) is turned off in response to the switch control signal SSW1. When the driving data DD(1) is finished, the driver 221(1) provides the second control signal SC2. Therefore, the switch controller 222(1) provides a switch control signal SSW2 to the control terminal of the switch SW(1) in response to the second control signal SC2. The switch SW(1) is turned on in response to the switch control signal SSW2.

In some embodiments, the switch controller 222(1) may be disposed inside the driver 221(1).

In the embodiment, the electronic device 220(2) includes a driver 221(2) and a switch controller 222(2). The driver 221(2) is coupled to the first terminal of the switch SW(2). The driver 221(2) controls the operation of the electronic device 220(2) according to the driving data DD(2). The switch controller 222(2) is coupled to the control terminal of the switch SW(2) and the driver 221(2). The switch controller 222(2) turns off the switch SW(2) in response to the first control signal SC1 from the driver 221(2). The switch controller 222(2) turns on the switch SW(2) in response to the second control signal SC2 from the driver 221(2).

Similarly, in the embodiment, the electronic device 220(n) includes a driver 221(n) and a switch controller 222(n). The driver 221(n) is coupled to the first terminal of the switch SW(n). The driver 221(n) controls the operation of the electronic device 220(n) according to the driving data DD(n). The switch controller 222(n) is coupled to the control terminal of the switch SW(n) and the driver 221(n). The switch controller 222(n) turns off the switch SW(n) in response to the first control signal SC1 from the driver 221(n). The switch controller 222(n) turns on the switch SW(n) in response to the second control signal SC2 from the driver 221(n).

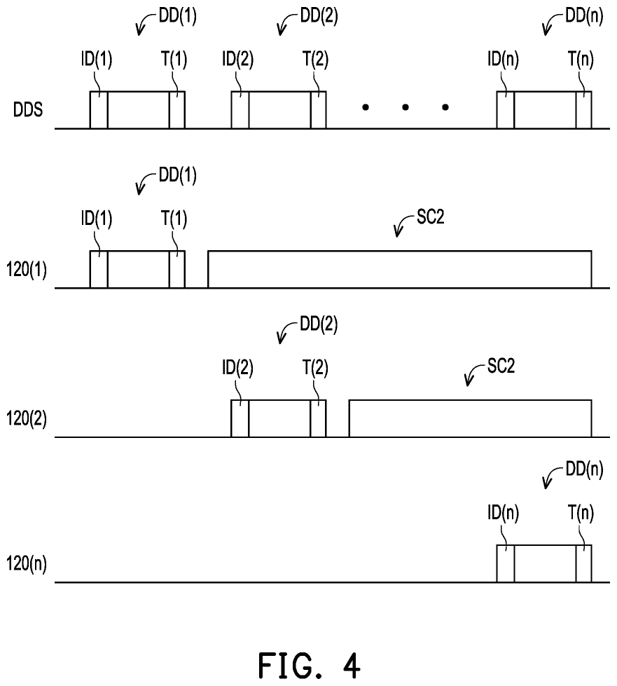

Referring to FIG. 3 and FIG. 4 at the same time, FIG. 4 is a signal timing diagram of a driving data string, a driving data, and a second control signal according to an embodiment of the invention. In the embodiment, FIG. 4 shows a signal timing diagram of the driving data string DDS and a signal timing diagram of the driving data and the second control signal SC2 corresponding to the electronic devices 220(1), 220(2), 220(n). In the embodiment, the driving data string DDS includes driving data DD(1) to DD(n) with different identification codes. The driving data DD(1) includes an identification code ID(1) and a trailer data T(1). The driving data DD(2) includes an identification code ID(2) and a trailer data T(2). Similarly, the driving data DD(n) includes an identification code ID(n) and a tail data T(n). In the embodiment, the driving data DD(1) to DD(n) are provided sequentially.

The driver 221(1) of the electronic device 220(1) receives and identifies the driving data DD(1) with the identification code ID(1), and receives the driving data DD(1). When the trailer data T(1) in the driving data DD(1) is received, it means that the receiving of the driving data DD(1) has been completed. In other words, the driver 221(1) receives the driving program or driving protocol in the complete driver data DD(1). Therefore, the driver 221(1) provides the second control signal SC2. The switch controller 222(1) turns on the switch SW(1) in response to the second control signal SC2.

After the switch SW(1) is turned on, the driver 221(2) of the electronic device 220(2) receives and identifies the driving data DD(2) with the identification code ID(2), and receives the driving data DD(2). When the trailer data T(2) in the driving data DD(2) is received, it means that the receiving of the driving data DD(2) has been completed. In other words, the driver 221(2) receives the driving program or driving protocol in the complete driving data DD(2). Therefore, the driver 221(1) provides the second control signal SC2. The switch controller 222(1) turns on the switch SW(1) in response to the second control signal SC2.

The driver 221(n) of the electronic device 220(n) receives and identifies the driving data DD(n) with the identification code ID(n), and receives the drive data DD(n). When the trailer data T(n) in the driving data DD(n) is received, it means that the receiving of the driving data DD(1) is completed. In other words, the driver 221(n) receives the driving program or driving protocol in the complete driving data DD(n). Therefore, the electronic system 100 completes the setting of the drivers 221(1) to 221(n).

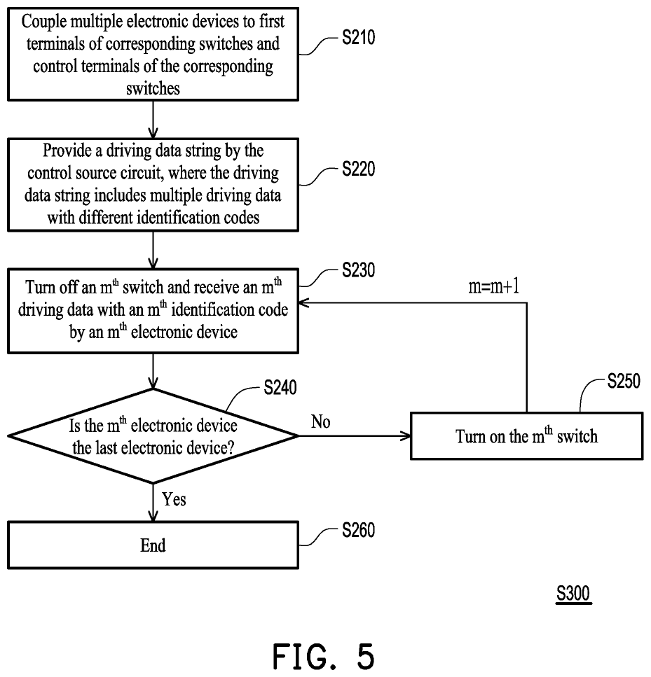

Referring to FIG. 1 and FIG. 5 at the same time, FIG. 5 is another flowchart of a setting method according to an embodiment of the invention. In the embodiment, a setting method S200 is adapted to the electronic system 100. The setting method S200 includes at least steps S210 to S260. In step S210, the electronic devices 120(1) to 120(n) are coupled to the first terminals of the corresponding switches and the control terminals of the corresponding switches. In step S220, the control source circuit 110 provides the driving data string DDS. The driving data string DDS includes driving data DD(1) to DD(n). The implementation details of steps S210 and S220 have been clearly described in the embodiment of FIG. 1, which will not be repeated here.

In step S230, an m^{th} electronic device turns off an m^{th} switch and receives an m^{th} driving data with an m^{th} identification code. In the embodiment, the electronic device 120(1) (i.e., m=1) turns off the switch SW(1) and receives the driving data DD(1). In step S240, after receiving the driving data DD(1), it is determined whether the electronic device 120(1) is the last electronic device. When it is determined that the electronic device 120(1) is not the last electronic device, the electronic device 120(1) turns on the switch SW(1) in step S250. Therefore, the electronic device 120(2) (i.e., m=2) turns off the switch SW(2) and receives the driving data DD(2) in step S230. In step S240, after receiving the driving data DD(2), it is determined whether the electronic device 120(2) is the last electronic device. When it is determined that the electronic device 120(2) is not the last electronic device, the electronic device 120(2) turns on the switch SW(2) in step S250, and so on.

In step S240, the electronic device 120(n) (i.e., m=n) turns off the switch SW(n) and receives the driving data DD(n). In step S240, after receiving the driving data DD(n), it is determined whether the electronic device 120(n) is the last electronic device. When it is determined that the electronic device 120(n) is the last electronic device, the setting method ends in step S240.

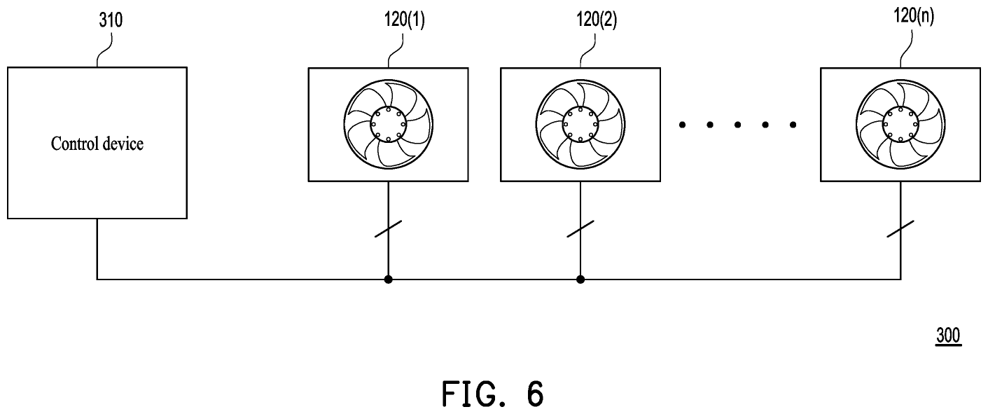

Referring to FIG. 1 and FIG. 6 at the same time, FIG. 6 is a schematic diagram of an application situation of an electronic device according to an embodiment of the invention. The electronic devices 120 (1) to 120(n) are, for example, respectively fan devices including display elements (the invention is not limited thereto). In the embodiment, the electronic devices 120 (1) to 120(n) and the control device 310 are integrated into a system 300. The control device 310 is used for controlling the electronic devices 120(1) to 120(n). The electronic devices 120(1) to 120(n) provide different operations according to the settings or protocols in the driving data DD(1) to DD(n). The operation is, for example, a fan speed, and a luminous brightness, a luminous color, or flashing mode of the display element. For example, when the electronic device 120(2) is damaged, a backup electronic device may be coupled to the first terminal of the switch SW(2) and the control terminal of the switch SW(2) of the electronic system 100. The backup electronic device is set to a new electronic device 120(2) based on the driving data DD(2). In this way, the user does not need to find a backup device capable of performing the same operations as the electronic device 120(2), nor does it need to manually configure the backup device as the new second electronic device. In addition, based on the electronic system 100, the electronic devices may have a same design and initial settings when being manufactured. The electronic system 100 may respectively configure the electronic devices as at least one of the electronic devices 120(1) to 120(n) according to actual requirements. In this way, the design cost of the electronic devices may be reduced.

In summary, the control source circuit provides the driving data with different identification codes. Based on the arrangement order of the electronic devices and the switching operations of the switches, the setting method of the invention is adapted for the electronic system to use the driving data to perform different settings to the driving methods of the electronic devices. set up. In this way, the invention may provide a highly convenient device setting solution. In addition, the electronic system may perform different settings on the electronic devices according to actual needs. The electronic devices may have the same design and initial settings when being manufactured. In this way, the design cost of the electronic devices may be reduced.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. An electronic system, comprising:
a control source circuit, configured to provide a driving data string, wherein the driving data string comprises a plurality of driving data with different identification codes;
a plurality of switches, coupled with each other in series, wherein a first terminal of a first switch among the switches is coupled to the control source circuit, wherein a first terminal of a second switch among the switches is coupled to a second terminal of the first switch; and
a plurality of electronic devices, wherein a first electronic device among the electronic devices is coupled to the first terminal of the first switch and a control terminal of the first switch, wherein a second electronic device among the electronic devices is coupled to the first terminal of the second switch and a control terminal of the second switch,
wherein the first electronic device turns off the first switch and receives a first driving data with a first identification code, and turns on the first switch after receiving the first driving data, so that the second electronic device receives a second driving data with a second identification code.

2. The electronic system according to claim 1, wherein the driving data are provided sequentially based on an order of the identification codes.

3. The electronic system according to claim 1, wherein
the electronic devices respectively have device codes, and
the device code of each of the electronic devices is determined according to an arrangement order of the electronic devices.

4. The electronic system according to claim 3, wherein
the electronic devices identify the identification codes according to the device codes of the electronic devices,
the first electronic device receives the first driving data with the first identification code based on a first device code of the first electronic device, and
the second electronic device receives the second driving data with the second identification code based on a second device code of the second electronic device.

5. The electronic system according to claim 1, wherein
the first electronic device operates according to the first driving data, and
the second electronic device operates according to the second driving data.

6. The electronic system according to claim 1, wherein the first electronic device comprises:
a driver, coupled to the first terminal of the first switch, and configured to control an operation of the first electronic device according to the first driving data.

7. The electronic system according to claim 6, wherein the first electronic device comprises:
a switch controller, coupled to the control terminal of the first switch and the driver, configured to turn off the first switch in response to a first control signal from the driver, and turn on the first switch in response to a second control signal from the driver.

8. The electronic system according to claim 7, wherein
when receiving the first driving data, the driver provides the first control signal, and
when finishing receiving the first driving data, the driver provides the second control signal.

9. The electronic system according to claim 1, wherein:
the first driving data comprises trailer data, and
when receiving the trailer data, the driver provides the second control signal.

10. A setting method for an electronic system, wherein the electronic system comprises a control source circuit, a plurality of switches, and a plurality of electronic devices, wherein a first terminal of a first switch among the switches is coupled to the control source circuit, and a first terminal of a second switch among the switches is coupled to a second terminal of the first switch, wherein the setting method comprises:
coupling a first electronic device among the electronic devices to the first terminal of the first switch and a control terminal of the first switch, and coupling a second electronic device among the electronic devices to the first terminal of the second switch and a control terminal of the second switch;
providing a driving data string by the control source circuit, wherein the driving data string comprises a plurality of driving data with different identification codes;
turning off the first switch and receiving a first driving data with a first identification code by the first electronic device; and
turning on the first switch by the first electronic device after receiving the first driving data, so that the second electronic device receives a second driving data with a second identification code.

11. The setting method according to claim 10, wherein providing the driving data string by the control source circuit comprises:
sequentially providing the driving data based on an order of the identification codes.

12. The setting method according to claim 10, wherein the electronic devices respectively have device codes, wherein the setting method further comprises:
determining the device code of each of the electronic devices according to an arrangement order of the electronic devices.

13. The setting method according to claim 12, further comprising:
receiving the first driving data with the first identification code by the first electronic device based on a first device code of the first electronic device; and
receiving the second driving data with the second identification code by the second electronic device based on a second device code of the second electronic device.

14. The setting method according to claim 10, wherein the first driving data comprises trailer data, wherein turning on the first switch after receiving the first driving data comprises:
turning on the first switch by the first electronic device when receiving the trailer data.
